(19) United States
(12) Patent Application Publication
(10) Pub. No.: US 2019/0052720 A1
(43) Pub. Date: Feb. 14, 2019

(54) DYNAMIC CANDIDATE POOL RETRIEVAL AND RANKING

(71) Applicant: Linkedln Corporation, Sunnyvale, CA (US)

(72) Inventors: Qi Guo, Sunnyvale, CA (US); Xianren Wu, San Jose, CA (US); Yan Yan, San Jose, CA (US); Bo Hu, Mountain View, CA (US); Ketan Thakkar, Santa Clara, CA (US); Shan Zhou, San Jose, CA (US); Anish Ramdas Nair, Mumbai (IN); Patrick Cheung, San Francisco, CA (US)

(21) Appl. No.: 15/671,148

(22) Filed: Aug. 8, 2017

(51) Int. Cl. H04L 29/08; G06F 17/30

(52) U.S. Cl. CPC H04L 67/306; H04L 51/32; H04L 67/22; G06F 17/30867

(57) ABSTRACT

Disclosed in some examples are methods, systems, and machine readable mediums which provide for retrieval, ranking, and display of candidates that are more likely to respond to employment inquiries in an employment search graphical user interface (GUI). The system may employ a machine learning algorithm which may calculate a score for each member of the social networking service that predicts, based upon one or more features how likely the individual is to respond to a message. In some examples, the candidates that are determined to be more likely to respond may be presented as a selectable option in the GUI.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an example Graphical User Interface (GUI) of an employment candidate search according to some examples of the present disclosure.

FIG. 2 shows an example GUI of an employment candidate search according to some examples of the present disclosure.

FIG. 3 shows a flowchart of an example method of providing a candidate list of members that are both relevant and likely to respond.

FIG. 4 shows an example machine learning module according to some examples of the present disclosure.

FIG. 5 shows a flowchart of a method of searching for members using a dynamic threshold according to some examples of the present disclosure.

FIG. 6 shows an example machine learning module according to some examples of the present disclosure.

FIG. 7 is a block diagram showing the functional components of a social networking service according to some examples of the present disclosure.

FIG. 8 is a block diagram illustrating an example of a machine upon which one or more embodiments may be implemented.

### DETAILED DESCRIPTION

Many of the examples described herein are provided in the context of a social or business networking website or service. However, the applicability of the inventive subject mat is not limited to a social or business networking service. The present inventive subject matter is generally applicable to a wide range of information and networked services. For example, the present inventive subject matter is applicable to online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Social networking services may be utilized by recruiters, employers, or other users to fill open job positions as social networking services store a wealth of information about members such as past work history and experience; education; skills; professional awards and accomplishments; and the like. This information may be searchable by the recruiter or employer in order to retrieve candidates that are relevant to an open position. While these searches may return relevant candidates to the searcher, it is not certain that these candidates are interested or responsive to being contacted by the recruiter or employer. For example, a member returned by the search may be happy in their current position, may not be very active on the social networking service (and thus not likely to answer communications), or the like. If the recruiter or company is looking to fill the position quickly, the recruiter or employer may decide that they would be happy with a slightly less relevant match in favor of a match that will respond quickly. The social networking service stores data that may assist in making a determination of whether the user is likely to respond to a job inquiry. This data may be leveraged to provide recruiters or companies with lists of candidates that are more likely to respond.

Disclosed in some examples are methods, systems, and machine readable mediums which provide for retrieval, ranking, and display of relevant members of a social networking service in a graphical user interface (GUI) that are predicted to be likely to respond to employment inquiries, or based upon other recruiter or employment tasks. The system may employ a machine learning algorithm which may calculate a likelihood of response score for each member of the social networking service that predicts, based upon one or more features, how likely the individual is to respond to a message about a job posting. The likelihood of response score is used along with the search criteria to return candidates (members of the social networking service) that are both relevant and likely to respond. These candidates may be presented in a GUI.

Traditionally, when a user like a recruiter is searching for candidates to fill a position, they will enter a search query and find quality candidates. However, when the identified candidates are contacted by the recruiter they may not respond perhaps because they are not looking to change jobs. Hence, the recruiter contacting these candidates is a waste of resources and delays the hiring process which prevents the company from operating at an optimal level. However, the described likelihood of response score allows a recruiter to find quality applicants that are more likely to communicate with the recruiter regarding their current situation and thus will allow the recruiter to fill a position faster. This solves the problem of wasted recruiter resources—which may include wasted funds in the form of money that is spent contacting out of network members and time in the form of waiting for a response.

When a recruiter, employer, or other user is searching the social networking service for members that would fit a particular job, the recruiter may enter a list of search criteria. Example search criteria include industries, job titles, salaries, locations, educations, experience, and the like. Given these criteria and the likelihood of response score, the system may utilize a number of ways to determine the candidates that are both relevant and likely to respond. For example, a standard relevance search may not initially factor in the likelihood of response and may utilize search algorithms that rank and retrieve members based upon how closely they match the given criteria. The relevant members returned by the standard search may then be filtered based upon likelihood of response scores. That is, relevant members may be removed if they do not have likelihood of response scores that are above a certain threshold. In these examples, the set of members determined to be relevant and most likely to respond are a subset of the members most relevant to the search criteria. In other examples, only members who have a likelihood of response score above the threshold may be searched by the relevance search. That is, the members are filtered based upon likelihood of response scores before the relevance search. In these examples, the set of members determined to be relevant and most likely to respond may be a subset or may include additional members not in the set of members most relevant to the search criteria. In still other examples, the likelihood of response scores are criteria that are weighted more heavily than other criteria. In these examples, the members may be weighted on a sliding scale—thus the more relevant a member the lower the likelihood of response score must be to be included in the results. Likewise, the higher the likelihood of response score the lower the relevance necessary to be included in the results. Thus, the likelihood of response score may be used before, as part of, or after the relevance-based search.

The likelihood of response score for a member may be calculated using one or more of a number of different features. Example features include features related to usage of the social networking service, page view data, communication related features, job opening features, and the like. Usage features may include login data for example, the date and/or time of the user's last login, how frequent logins are, and/or the like. Other example usage features include page view data—such as the date and/or time of the last page view, a frequency of page views, a profile quality score that quantifies the perceived completeness and quality of a member profile, profile information, and/or the like. Features used in the likelihood of response score may also include communication related features. For example, how frequently the user sends messages through the social networking service, how frequently the user responds to messages from others, including how frequently the user responds to messages from users that are not a direct connection (e.g., are a 2^{nd} degree connection or further). Other communication features may include content post histories such as how frequently the user posts content. Features used in the likelihood of response score may also include job opening features such as a “job seeker score” that quantifies a predicted likelihood that the member is seeking employment, and the like. Scores may be calculated by utilizing one or more machine learning algorithms, or by assigning points to features (e.g., a point for a login within the last week) and utilizing a weighted summation, where the weights are predetermined or machine learned.

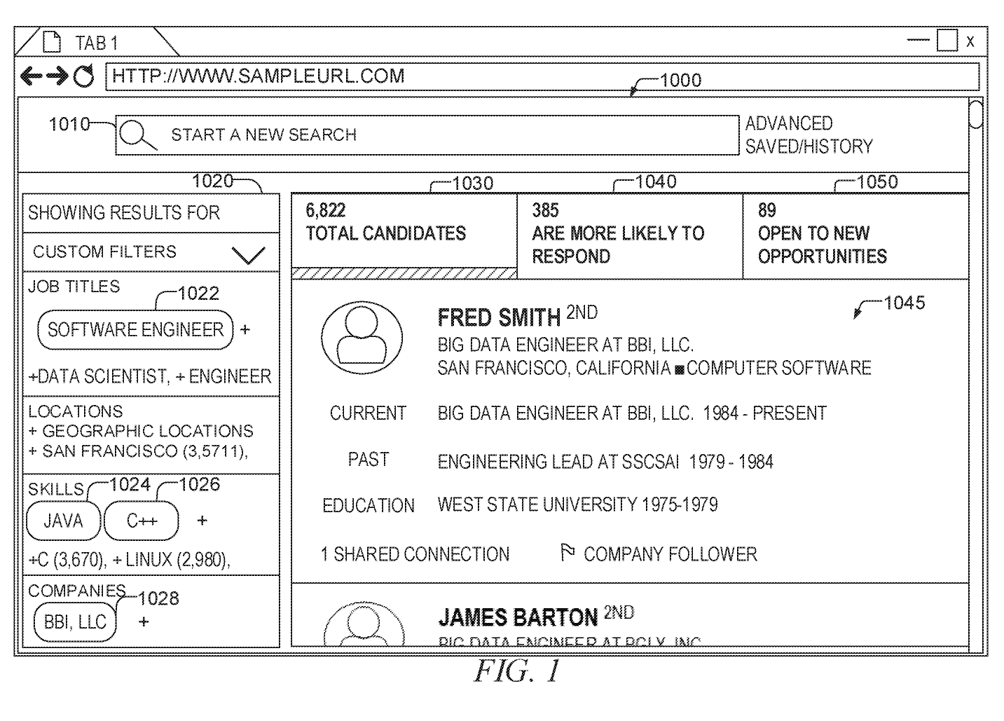

FIG. 1 shows an example GUI 1000 of an employment candidate search according to some examples of the present disclosure. The GUI 1000 is shown as part of a browser application, but may be provided as part of a dedicated social networking application. The user may enter various search criteria, for example, the user may enter criteria as free text through GUI element 1010. This free-text criteria may comprise one or more keywords which may be matched to any element in a member's profile. For example, if the keyword is “JACK” the returned profiles may have a first name of “JACK”, a last name of “JACK”, may work for a company with “JACK” somewhere in the company name, and the like. Specific filters box 1020 allows a user to specifically search against particular social networking member information, such as job titles, locations, skills, companies, and the like. The job titles, locations, skills, and other boxes include suggestions (e.g., to add a data scientist or engineer job title; add a San Francisco location; add a C and Linux skill; and the like) and in some examples, the number of matching members with that information. Bubbles, such as bubbles 1022, 1024, 1026, and 1028 are GUI elements that visually indicate the current criteria. Thus bubble 1022 indicates that the user has entered a job title of software engineer. Clicking on the “+” icon next to the bubbles allows the user to add another criteria to that field. The suggested criteria are shown with a plus next to them (e.g., “+data scientist”) and may be added as search criteria by clicking, tapping, or otherwise selecting them.

Results tab 1030 selects all results in the results window 1045 and also indicates the number of total results (6,822). Selecting this tab will populate the results window 1045 with information about the members matching the search criteria. As shown in FIG. 1, “Fred Smith” is the top result, followed by “James Barton.” The list is scrollable (in the case of FIG. 1, downwardly). The user may click on, or otherwise select one of the users and view their profile or additional information; email the user; or the like.

By selecting (e.g., clicking, tapping, touching, or the like) the more likely to respond tab 1040 (which also shows the number of more likely to respond results—385), the system may perform a search as described herein that utilizes the likelihood of response score to retrieve candidates that are more likely to respond. As previously described, the members returned by the more likely to respond option may or may not be a subset of the total candidates. The open to new opportunities tab 1050 is a list of members from the total candidates that are determined by the social networking service to be seeking new employment.

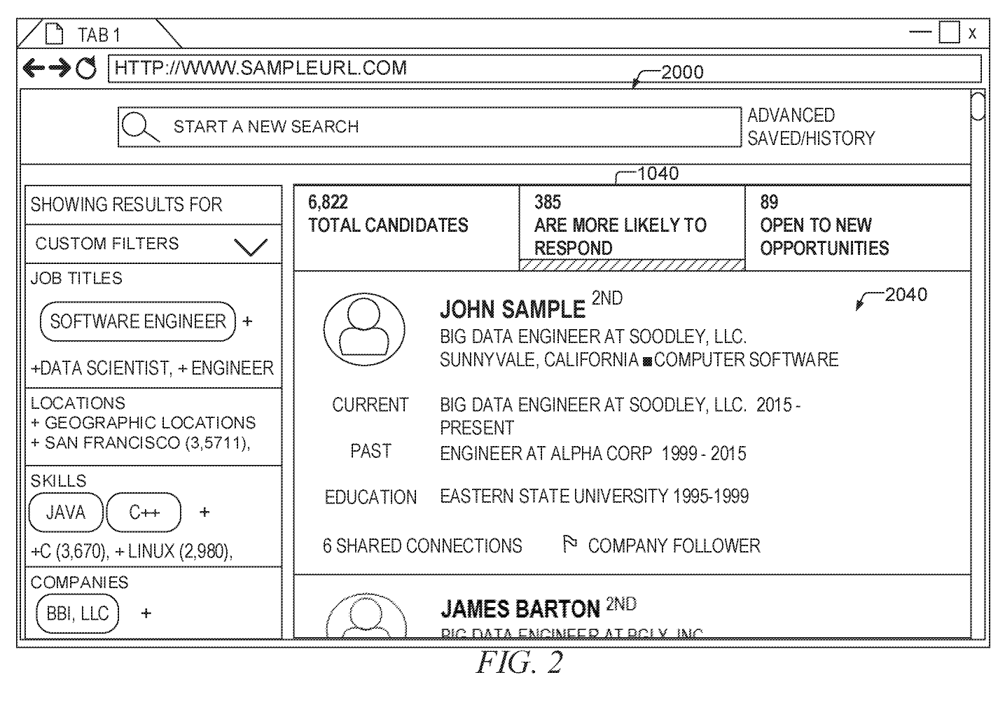

FIG. 2 shows an example GUI 2000 of an employment candidate search according to some examples of the present disclosure. The more likely to respond tab 1040 has been selected and the results area 2040 now shows a ranked list of candidates who are more likely to respond. The candidates returned as a result of this tab are relevant candidates whose likelihood of response exceeds a given threshold. In some examples, this threshold may be predetermined (e.g., by an administrator of the social networking service), and in other examples, this threshold may be dynamic based upon the searcher and/or the search query. For example, the threshold may be higher for instances in which there are a lot of relevant results (e.g., software engineers in San Francisco) and lower to return more results where there are fewer relevant results (e.g., a marine biologist in North Dakota).

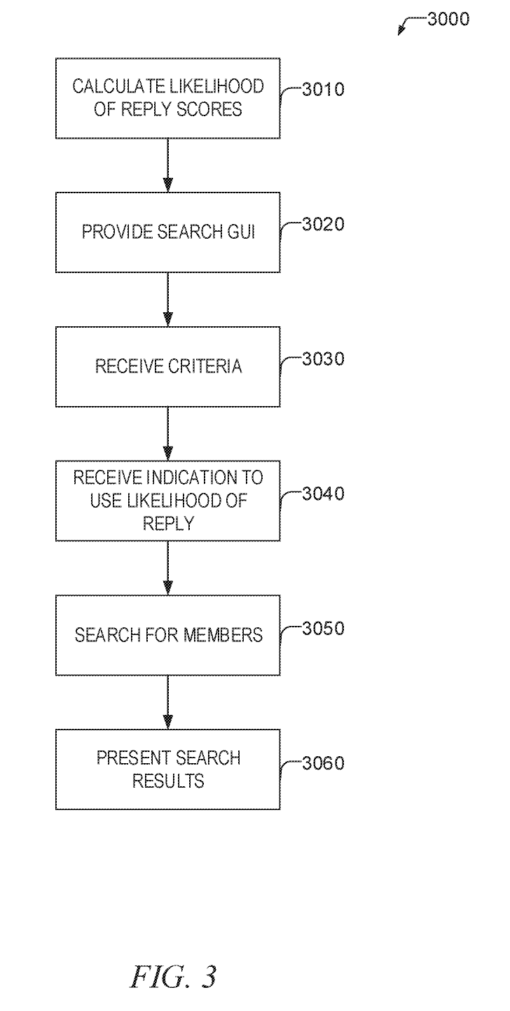

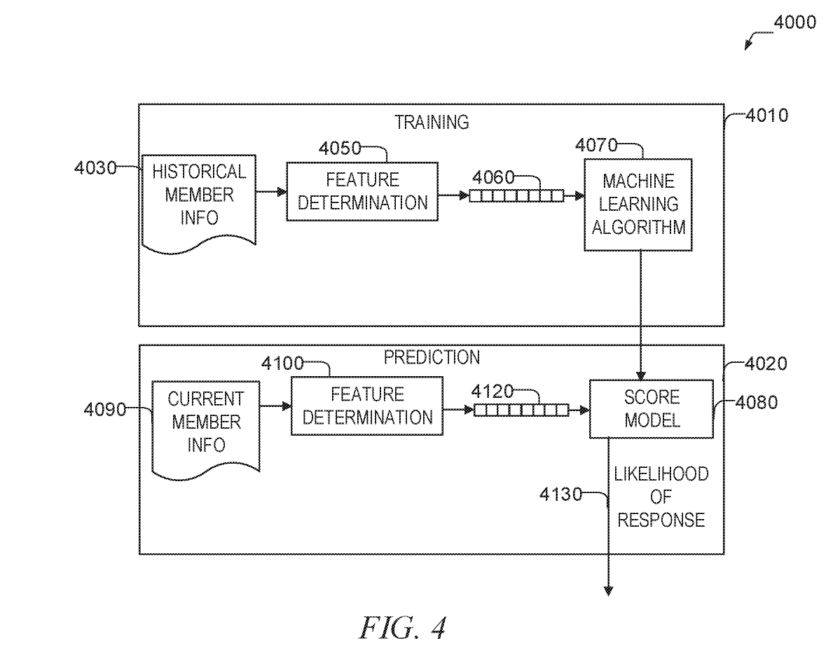

FIG. 3 shows a flowchart of an example method 3000 of providing a candidate list of members that are both relevant and likely to respond. At operation 3010 the system calculates likelihood of response scores for members. In this embodiment, operation 3010 is performed in advance of a search query for relevant members that are likely to respond. However, in other embodiments, operation 3010 may be performed after a search query is received. In some examples, the score may be calculated based upon one or more features—for example, based upon usage features, communications features, profile features, and the like of each user. In some examples, the values of one or more of the features may be assigned point values based upon rules (e.g., if the member responds 0-20% of the time from out-of-network communications, then 0 points, 21-50% then 1 points, 51-75% then 3 points, over 75% then 4 points, and the like) that may then be summed to produce a likelihood of response score. In other examples, the values for one or more of these features may be input into a machine learning model to produce the likelihood of response score. The machine learning model approach is discussed further with respect to FIG. 4.

At operation 3020 the system provides a search GUI to a user (e.g., a member of the social networking service, such as a recruiter). The search GUI may be provided by sending one or more GUI descriptors. GUI descriptors may be one or more files that describe the layout and/or content of the GUI. For example, one or more of Hypertext Markup Language (HTML) files, Java files, JavaScript files, scripting files. Extensible Markup Language (XML) files, data files describing data for one or more fields of a GUI, Content Style Sheets, and/or the like. These GUI descriptors may be received by an application on a computing device of the user and utilized to create the GUI. For example, a browser may render the GUI. In other examples a social networking application may utilize the GUI descriptors to render the GUI.

At operation 3030 the user submit a search query to the system and the system receives the search query. The search query includes search criteria, such as a member name, current employment position, past employment positions, current or past companies, current or past education, industry, skills, years of experience, location, salary, and/or the like. These criteria may be entered free text or may be entered through one or more GUI elements (e.g., drop down boxes, or other GUI elements such as shown in FIGS. 1 and 2). in some examples, the system conducts the search to find relevant results based upon the criteria in the search query. Those results may be returned to the user (e.g., such as shown in FIG. 1).

At operation 3040 the system receives an indication that the user is interested in results that are both relevant and include users that have a high likelihood of responding. For example, the user has selected the more likely to respond tab 1040, or indicated that they wish to see candidates that are more likely to respond when submitting the initial search query at operation 3030. At operation 3050 the system searches for members based upon the criteria and the likelihood of response scores. As previously noted, the members may be filtered before, after, or as part of the relevance based search. At operation 3060 the search results are presented, e.g., through one or more GUIs—e.g., based upon creating or updating one or more GUI descriptors sent to a client device of the user.

FIG. 4 shows an example machine learning module 4000 executed by the system according to some examples of the present disclosure. Machine learning module 4000 is one example method of calculating likelihood of response scores in operation 3010 of FIG. 3. Machine learning module 4000 utilizes a training module 4010 and a prediction module 4020. Training module 4010 inputs historical member information 4030 into feature determination module 4050. Example historical member information includes one or more of: login data—e.g., last login, frequency of logins; page view data; communication data related to communications (e.g., email or messaging) through the social networking service (e.g., response time to messages from connections, messages from members that are not connected to them, sending messages); content post histories (frequency of posting); a “job seeker score” that quantifies a predicted likelihood that the member is seeking employment; a profile quality score that quantifies the perceived completeness and quality of a member profile; profile information; and/or the like. The historical member information 4030 may be labeled indicating whether or not the user is likely to respond to communications about job offers. In some examples, the historical member data may be from a period just before and/or just after a job offer communication is sent to the member and the label may be whether or not the member responded within a predetermined time period.

Feature determination module 4050 determines one or more features 4060 from this information. Features 4060 are a set of the information input and is information determined to be predictive of a response. In some examples, the features 4060 may be all the historical activity data. The machine learning algorithm 4070 produces a score model 4080 based upon the features 4060 and the label.

in the prediction module 4020, the current member information 4090 may be input to the feature determination module 4100. Feature determination module 4100 may determine the same set of features or a different set of features as feature determination module 4050. In some examples, feature determination module 4100 and 4050 are the same module. Feature determination module 4100 produces a feature vector 4120, which is input into the score model 4080 to generate a likelihood of response score 4130. The training module 4010 may operate in an offline manner to train the score model 4080. The prediction module 4020, however, may be designed to operate in an online manner. It should be noted that the score model 4080 may be periodically updated via additional training and/or user feedback. For example, additional historical member information 4030 may be collected as job opportunities are sent and replied to, or not replied to.

The machine learning algorithm 4070 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training module 4010. In an example embodiment, a linear regression model is used and the score model 4080 is a vector of coefficients corresponding to a learned importance for each of the features in the vector of features 4060, 4120. To calculate a score, a dot product of the feature vector 4120 and the vector of coefficients of the score model 4080 is taken.

As stated previously, the candidates may be searched as normal (without considering the likelihood of response score) and then those returned candidates may be filtered to remove all candidates that have likelihood of response scores below a particular threshold. In other examples, the search may be altered so as to factor in the likelihood of response score. In these examples, the set of members of the social networking service that have likelihood of response thresholds that are above a particular threshold may be searched using the standard search algorithms that find relevant members from the subset of members who have likelihood of response scores that are above a predetermined threshold. In still other examples, the standard search algorithms may also utilize the likelihood of response score as one of the search criteria such that likelihood of response is utilized as a relevance criteria in selecting and ranking the search results.

As previously described, the system utilizes a likelihood of response threshold. If the threshold is too low, then the members shown may not be likely to respond. If the threshold is too high, there might not be enough members that meet the likelihood of response and thus the result set may be sparse. As noted, in some examples, a predetermined threshold may be utilized. This may produce results that are too sparse in some instances. In other examples, the threshold may be dynamically determined with every search request based upon the context of the search. The search context may be personalized information based upon the searcher and may comprise the context of the searcher, the context of the search query, the quantity of search results, or the like. For example, the threshold may depend on the query title, industry, skill, area, company that the position is for, user that is doing the searching, and the like. For example, the threshold may depend on the query title, industry, skill, area, company that the position is for, user that is doing the searching, and the like. Thus, the likelihood of response threshold may vary depending on who is searching, what the query is, how may search results are returned, and the like. In general, the search context may be defined as information about the circumstances of the search.

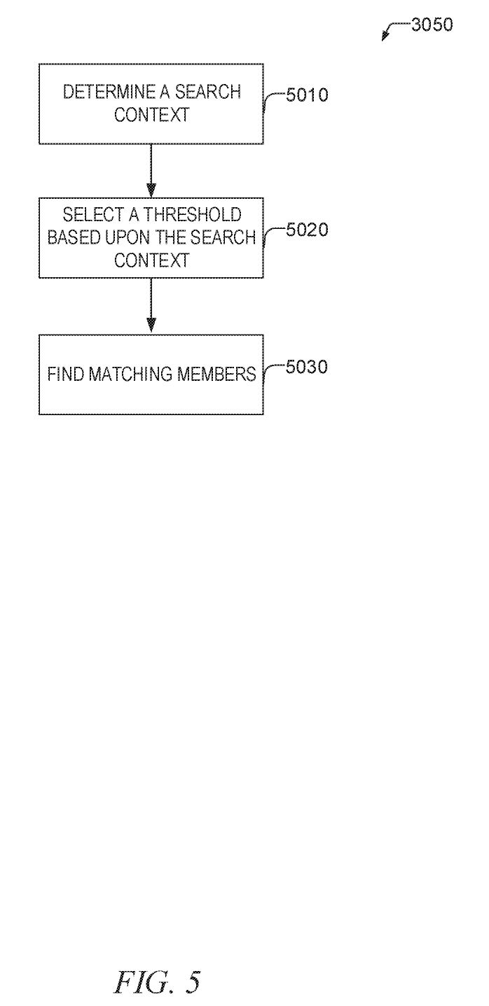

Turning now to FIG. 5 a flowchart of a method 3050 of searching for members using a dynamic threshold is shown according to some examples of the present disclosure. The method of FIG. 5 is one example implementation of operation 3050 of FIG. 3 where the threshold is dynamically determined. At operation 5010 the search context may be determined. As previously noted, the search context may comprise the search criteria, information about the searcher, information about the search results, information from the searcher (e.g., a desired date to fill the job, and the like. This information may be obtained from a member profile of the searching member, a member profile of the company that the job opening is for, the search criteria, a first pass relevance search (e.g., the criteria may be searched to determine a number of search results), and the like.

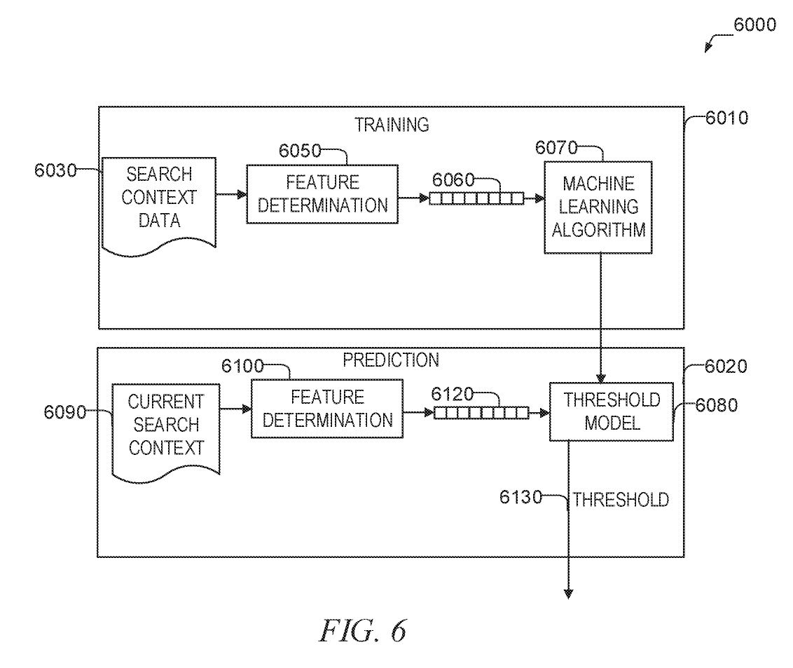

At operation 5020 a threshold may be selected based upon the search context. The context of the search may be utilized as inputs into one or more if-then rules or decision trees to produce a threshold. For example: if the job location is Fargo, and the job is marine biologist, then set the threshold to value X. In other examples, a machine learning model is utilized to select the threshold based upon the search context. This will be described with respect to FIG. 6. At operation 5030 the system may find relevant members who meet the threshold likelihood of response. In some examples, the matching members may be ranked in an order based upon relevance.

FIG. 6 shows an example machine learning module 6000 according to some examples of the present disclosure. Machine learning module 6000 is one example method of calculating a threshold in operation 5020 of FIG. 5. Machine learning module 6000 utilizes a training module 6010 and a prediction module 6020. Training module 6010 feeds historical search context data 6030 into feature determination module 6050. Example historical search context data 6030 may comprise the context of the searcher, the context of the search query, the quantity of search results, or the like for one or more historical searches. These may be labelled with a desired or appropriate threshold (e.g., by an administrator, a searcher, or the like). In other examples, the label (e.g., the desired threshold) may be calculated using an algorithm based upon the number of search results vs the likelihood of response scores. For example, the algorithm may determine the likelihood of response score at which a predetermined number of applicants qualify. This likelihood of response score may be the label applied to the search context data.

Feature determination module 6050 determines one or more features 6060 from this information. Features 6060 are a set of the information input and is information determined to be predictive of a threshold that matches the label of the search context data 6030. In some examples, the features 6060 may be all the historical search context data. The machine learning algorithm 6070 produces a threshold model 6080 based upon the features 6060 and the label.

In the prediction module 6020, the current search context data 6090 may be input to the feature determination module 6100. Current search context data 6090 may be a current search context for a current search. Feature determination module 6100 may determine the same set of features or a different set of features as feature determination module 6050. In some examples, feature determination module 6100 and 6050 are the same module. Feature determination module 6100 produces feature vector 6120, which are input into the threshold model 6080 to generate a threshold 6130. The training module 6010 may operate in an offline manner to train the threshold model 6080. The prediction module 6020, however, may be designed to operate in an online manner. It should be noted that the threshold model 6080 may be periodically updated via additional training and/or user feedback. For example, additional search context data may be collected as search results are returned. For example, if the threshold is too high and produces too few search results, the threshold may be increased and the threshold model 6080 may be adjusted to correct for this in the future.

The machine learning algorithm 6070 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training module 6010. In an example embodiment, a linear regression model is used and the threshold model 6080 is a vector of coefficients corresponding to a learned importance for each of the features in the vector of features 6060, 6120. To calculate a threshold, a dot product of the feature vector 6120 and the vector of coefficients of the threshold model 6080 is taken.

In yet other examples, the user may provide input to how much to weigh the likelihood of response. For example, if the user needs to fill a position in the next month, the likelihood of response may be more important than if the user is looking to till the position in the next quarter. In some examples, the user may input when they need the position filled by. The quicker the need to fill the position the higher the threshold may be set. In some examples, users may have a relevance slider where relevance is on one side and likelihood of response is on the other side and the position of the slider is a weighting of the importance of relevance vs likelihood of response. Moving the slider towards likelihood of response may decrease the relevance of responses but increase their likelihood of responding (and filling the position). Moving the slider towards relevance may increase the relevance of responses but may decrease the likelihood of response. In some examples, the relevance of a user may have a score and the likelihood of response score may be added together to produce a final relevance score where the relevance score and the likelihood of response scores are weighted based upon user selected weights (e.g., based upon a numerical conversion of the position of the slider). Candidates above a threshold combined relevance and likelihood of response score may be presented to the searching user.

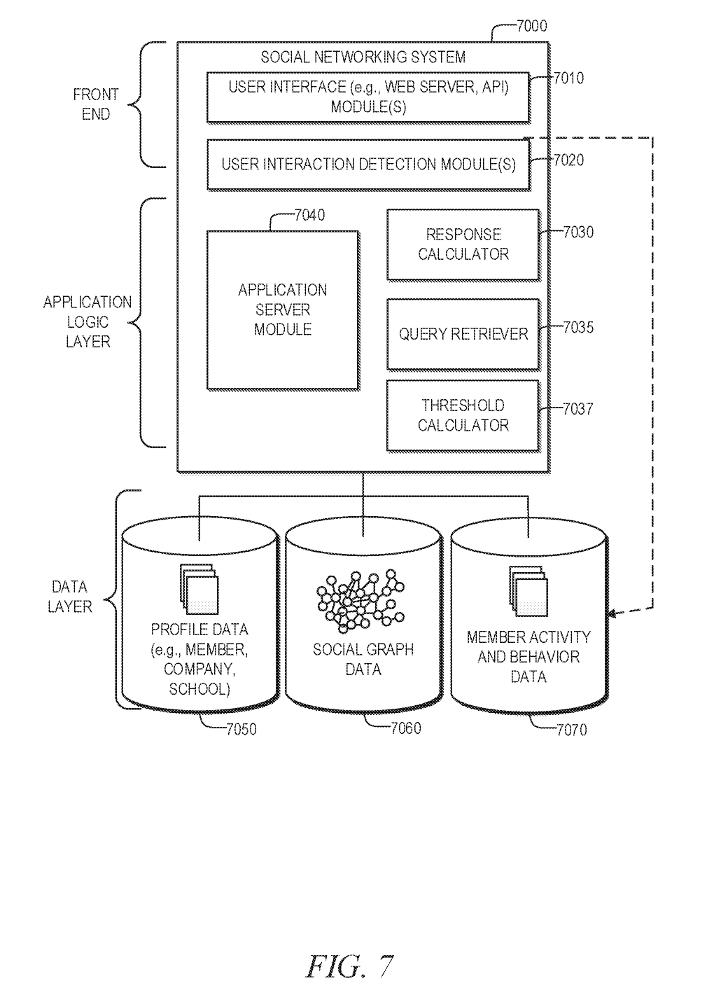

FIG. 7 is a block diagram showing the functional components of a social networking system 7000 that provides the described social networking service. As shown in FIG. 7, a front end may comprise a user interface module (e.g., a web server) 7010, which receives requests from various client-computing devices, and communicates appropriate responses to the requesting client devices. For example, the user interface module(s) 7010 may receive requests in the form of Hypertext Transport Protocol (HTTP) requests, or other network-based, application programming interface (API) requests (e.g., from a dedicated social networking service application running on a client device). In addition, a member interaction and detection module 7020 may be provided to detect various interactions that members have with different applications, services and content presented. As shown in FIG. 7, upon detecting a particular interaction, the member interaction and detection module 7020 logs the interaction, including the type of interaction and any meta-data relating to the interaction, in the member activity and behavior database 7070.

An application logic layer may include one or more various application server modules 7040, which, in conjunction with the user interface module(s) 7010, generate various graphical user interfaces (e.g., web pages) with data retrieved from various data sources in the data layer. With some embodiments, application server module 7040 is used to implement the functionality associated with various applications and/or services provided by the social networking service as discussed above.

Application layer may include response calculator 7030 which may calculate likelihood of response scores for one or more members of the social networking service as described herein. Application layer may include a query retriever 7035 for performing relevance based searches for members matching search criteria. The query retriever 7035 may also consider and factor in the likelihood of response, for example, by performing the operations of FIGS. 3 and 4. In some examples, the application layer may also include a threshold calculator 7037 which may calculate a likelihood of response threshold for use by the query retriever 7035—for example, by implementing FIGS. 5 and 6.

The data layer may include one or more data storage entities or databases such as profile database 7050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the profile database 7050. Similarly, when a representative of an organization initially registers the organization with the social networking service, the representative may be prompted to provide certain information about the organization. This information may be stored, for example, in the profile database 7050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 7060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 7 by the member activity and behavior database 7070.

With some embodiments, the social networking system 7000 provides an application programming interface (API) module with the user interface module 7010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

While the disclosure refers to a likelihood of response ordering and ranking, in other examples, candidates may be sorted, ranked, and/or selected based upon other hiring contexts. For example, the system may prioritize highly interested candidates for employers who need to fill a role quickly. These candidates may be sorted and ranked based upon a job seeker score (a measure of how actively they are looking for jobs—e.g., by behavior analytics), member lifecycle data (if they are active on the social networking service), open candidate, shared connections with the company, whether they are approaching an average tenure for their position, and the like. In other examples, the system may sort, rank, and/or select candidates who are the most qualified candidates for employers that wish to make a perfect hire. The system may utilize a match/relevancy score, whether the candidate is employed at a top company (e.g., based upon a list of top companies), and the like. In yet other examples, the user may prioritize, rank, and select candidates based upon affordability. In these examples, the system may prioritize, rank, and select candidates that are affordable. The system may prioritize candidates that are internal, have a low salary expectation (e.g., as compared with peers and as determined by a survey), are local (e.g., to avoid relocation expenses), and may prioritize those candidates who are a career level lower than the position that is offered. In still yet other examples, the system may assist recruiters or organizations that have been searching to fill the position for a long time. The system may attempt to tap previously untapped talent pools by a more aggressive query expansion to include more candidates in the search results, expand the query to include candidates in nearby locations or that are willing to relocate, find people on other social networking or job services, and focus on candidates that already work at the company. In more examples, if the social networking service charges members to send messages to other members that are not in their network or based upon other criteria, then the system may allow users to prioritize candidates that would be free or lower cost to message. For example, the system may filter by open profile, first degree connections (e.g., members within their network), and the like.

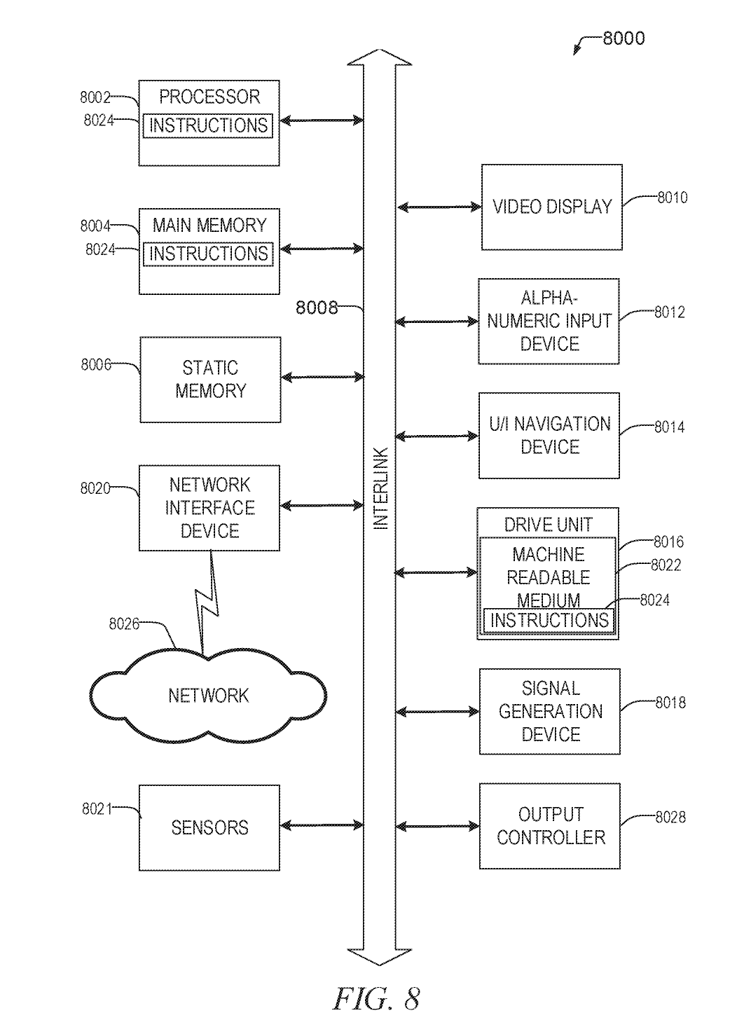

FIG. 8 illustrates a block diagram of an example machine 8000 upon which any one or more of the techniques (e.g., methodologies) discussed herein may perform. In alternative embodiments, the machine 8000 may operate as a standalone device or may be connected (e.g., networked) to other machines. In a networked deployment, the machine 8000 may operate in the capacity of a server machine, a client machine, or both in server-client network environments. In an example, the machine 8000 may act as a peer machine in peer-to-peer (P2P) (or other distributed) network environment. The machine 8000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. The machine 8000 may implement the social networking system 7000 (e.g., in whole or in part), be configured to produce the GUIs of FIGS. 1, 2, perform the methods of FIGS. 3 and 5, and perform the machine learning shown in FIGS. 4 and 6. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 8000 may include a hardware processor 8002 (e.g., a central processing unit (CPU), a graphics processing unit (GPU), a hardware processor core, or any combination thereof), a main memory 8004 and a static memory 8006, some or all of which may communicate with each other via an interlink (e.g., bus) 8008. The machine 8000 may further include a display unit 8010, an alphanumeric input device 8012 (e.g., a keyboard), and a user interface (UI) navigation device 8014 (e.g., a mouse). In an example, the display unit 8010, input device 8012 and UI navigation device 8014 may be a touch screen display. The machine 8000 may additionally include a storage device (e.g., drive unit) 8016, a signal generation device 8018 (e.g., a speaker), a network interface device 8020, and one or more sensors 8021, such as a global positioning system (GPS) sensor, compass, accelerometer, or other sensor. The machine 8000 may include an output controller 8028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 8016 may include a machine readable medium 8022 on which is stored one or more sets of data structures or instructions 8024 (e.g., software) embodying or utilized by any one or more of the techniques or functions described herein. The instructions 8024 may also reside, completely or at least partially, within the main memory 8004, within static memory 8006, or within the hardware processor 8002 during execution thereof by the machine 8000. In an example, one or any combination of the hardware processor 8002, the main memory 8004, the static memory 8006, or the storage device 8016 may constitute machine readable media.

While the machine readable medium 8022 is illustrated as a single medium, the term “machine readable medium” may include a single medium or multiple media (e.g., a centralized or distributed database, and/or associated caches and servers) configured to store the one or more instructions 8024.

The term “machine readable medium” may include any medium that is capable of storing, encoding, or carrying instructions for execution by the machine 8000 and that cause the machine 8000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only. Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 8024 may further be transmitted or received over a communications network 8026 using a transmission medium via the network interface device 8020. The Machine 8000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 8020 may include one or more physical jacks (e.g., Ethernet, coaxial, or phone jacks) or one or more antennas to connect to the communications network 8026. In an example, the network interface device 8020 may include a plurality of antennas to wirelessly communicate using at least one of single-input multiple-output (SIMO), multiple-input multiple-output (MIMO), or multiple-input single-output (MISO) techniques. In some examples, the network interface device 8020 may wirelessly communicate using Multiple User MIMO techniques.

### OTHER NOTES AND EXAMPLES

Example 1 is a method for providing a graphical user interface (GUI), the method comprising: using one or more processors of a social networking service, executing operations of: for each particular member of a plurality of members of the social networking service, determining, using a machine learning algorithm, a response score for the particular member based upon one or more of activity data describing the particular member's activity on the social networking service, and profile data, the response score indicative of a likelihood of the particular member to respond to an inquiry about a job from another member of the social networking service; causing a search GUI to be displayed to a user, the search GUI including GUI elements that receive search criteria; receiving through the search GUI, a search query with member search criteria; responsive to the search query, identifying a set of members from the plurality of members based on the response score determined for each particular member from the set of members; and causing the set of members to be displayed to the user as search results for the search query.

In Example 2, the subject matter of Example 1 optionally includes wherein receiving through the search GUI, the search query with member search criteria comprises: receiving the member search criteria; determining a set of relevant members based upon the member search criteria; presenting the set of relevant members in the search GUI; and receiving a selection of a GUI element of the search GUI indicating that the user is interested in other members that have high predicted propensities to respond.

In Example 3, the subject matter of any one or more of Examples 1-2 optionally include wherein identifying the set of members from the plurality of members based on the response score comprises identifying members from the plurality of members that match the member search criteria and that have a response score above a predetermined threshold.

In Example 4, the subject matter of any one or more of Examples 1-3 optionally include wherein identifying the set of members comprises: determining an initial set of members of the social networking service that have response scores above a predetermined threshold; and searching the initial set of members based upon the search criteria to produce the set of members.

In Example 5, the subject matter of any one or more of Examples 1-4 optionally include wherein identifying the set of members comprises: searching for an initial set of members based upon the search criteria to produce an initial set of members; and removing from the set of initial members, members that have response scores below a predetermined threshold to produce the set of members.

In Example 6, the subject matter of any one or more of Examples 1-5 optionally include wherein calculating the response scores comprises calculating the response score based upon social networking service member information comprising usage features, communication features, and job opening features.

In Example 7, the subject matter of any one or more of Examples 1-6 optionally include wherein calculating the response score comprises calculating the response score based upon a job seeker score that quantifies a predicted likelihood that the particular member is seeking employment, login data, profile quality score, and how frequently the particular member responds to communications from other members that are not connections.

Example 8 is a non-transitory machine-readable medium comprising instructions, when executed by a machine, causes the machine to perform operations comprising: for each particular member of a plurality of members of the social networking service, determining, using a machine learning algorithm, a response score for the particular member based upon one or more of: activity data describing the particular member's activity on the social networking service, and profile data, the response score indicative of a likelihood of the particular member to respond to an inquiry about a job from another member of the social networking service; causing a search GUI to be displayed to a user, the search GUI including GUI elements that receive search criteria; receiving through the search GUI, a search query with member search criteria; responsive to the search query, identifying a set of members from the plurality of members based on the response score determined for each particular member from the set of members; and causing the set of members to be displayed to the user as search results for the search query.

In Example 9, the subject matter of Example 8 optionally includes wherein the operations of receiving through the search GUI, the search query with member search criteria comprises: receiving the member search criteria; determining a set of relevant members based upon the member search criteria; presenting the set of relevant members in the search GUI; and receiving a selection of a GUI element of the search GUI indicating that the user is interested in other members that have high predicted propensities to respond.

In Example 10, the subject matter of any one or more of Examples 8-9 optionally include wherein the operations of identifying the set of members from the plurality of members based on the response score comprises identifying members from the plurality of members that match the member search criteria and that have a response score above a predetermined threshold.

In Example 11, the subject matter of any one or more of Examples 8-10 optionally include wherein the operations of identifying the set of members comprises: determining an initial set of members of the social networking service that have response scores above a predetermined threshold; and searching the initial set of members based upon the search criteria to produce the set of members.

In Example 12, the subject matter of any one or more of Examples 8-11 optionally include wherein the operations of identifying the set of members comprises: searching for an initial set of members based upon the search criteria to produce an initial set of members; and removing from the set of initial members, members that have response scores below a predetermined threshold to produce the set of members.

In Example 13, the subject matter of any one or more of Examples 8-12 optionally include wherein the operations of calculating the response scores comprises calculating the response score based upon social networking service member information comprising usage features, communication features, and job opening features.

In Example 14, the subject matter of any one or more of Examples 8-13 optionally include wherein the operations of calculating the response score comprises calculating the response score based upon a job seeker score that quantifies a predicted likelihood that the particular member is seeking employment, login data, profile quality score, and how frequently the particular member responds to communications from other members that are not connections.

Example 15 is a system comprising: a processor; a memory, the memory communicatively coupled to the processor and comprising instructions, the instructions, when executed b the processor, cause the processor to perform the operations of: for each particular member of a plurality of members of the social networking service, determining, using a machine learning algorithm, a response score for the particular member based upon one or more of: activity data describing the particular member's activity on the social networking service, and profile data, the response score indicative of a likelihood of the particular member to respond to an inquiry about a job from another member of the social networking service; causing a search GUI to be displayed to a user, the search GUI including GUI elements that receive search criteria; receiving through the search GUI, a search query with member search criteria; responsive to the search query, identifying a set of members from the plurality of members based on the response score determined for each particular member from the set of members; and causing the set of members to be displayed to the user as search results for the search query.

In Example 16, the subject matter of Example 15 optionally includes wherein the operations of receiving through the search GUI, the search query with member search criteria. comprises: receiving the member search criteria; determining a set of relevant members based upon the member search criteria; presenting the set of relevant members in the search GUI; and receiving a selection of a GUI element of the search GUI indicating that the user is interested in other members that have high predicted propensities to respond.

In Example 17, the subject matter of any one or more of Examples 15-16 optionally include wherein the operations of identifying the set of members from the plurality of members based on the response score comprises identifying members from the plurality of members that match the member search criteria and that have a response score above a predetermined threshold.

In Example 18, the subject matter of any one or more of Examples 15-17 optionally include wherein the operations of identifying the set of members comprises: determining an initial set of members of the social networking service that have response scores above a predetermined threshold; and searching the initial set of members based upon the search criteria to produce the set of members.

In Example 19, the subject matter of any one or more of Examples 15-18 optionally include wherein the operations of identifying the set of members comprises: searching for an initial set of members based upon the search criteria to produce an initial set of members; and removing from the set of initial members, members that have response scores below a predetermined threshold to produce the set of members.

In Example 20, the subject matter of any one or more of Examples 15-19 optionally include wherein the operations of calculating the response scores comprises calculating the response score based upon social networking service member information comprising usage features, communication features, and job opening features.

In Example 21, the subject matter of any one or more of Examples 15-20 optionally include wherein the operations of calculating the response score comprises calculating the response score based upon a job seeker score that quantifies a predicted likelihood that the particular member is seeking employment, login data, profile quality score, and how frequently the particular member responds to communications from other members that are not connections.

Example 22 is a device for providing a graphical user interface (GUI), the device comprising: for each particular member of a plurality of members of the social networking service, means for determining, using a machine learning algorithm, a response score for the particular member based upon one or more of: activity data describing the particular member's activity on the social networking service, and profile data, the response score indicative of a likelihood of the particular member to respond to an inquiry about a job from another member of the social networking service; means for causing a search GUI to be displayed to a user, the search GUI including GUI elements that receive search criteria; means for receiving through the search GUI, a search query with member search criteria; responsive to the search query, means for identifying a set of members from the plurality of members based on the response score determined for each particular member from the set of members; and means for causing the set of members to be displayed to the user as search results for the search query.

In Example 23, the subject matter of Example 22 optionally includes wherein the means for receiving through the search GUI, the search query with member search criteria comprises: means for receiving the member search criteria; means for determining a set of relevant members based upon the member search criteria; means for presenting the set of relevant members in the search GUI; and means for receiving a selection of a GUI element of the search GUI indicating that the user is interested in other members that have high predicted propensities to respond.

In Example 24, the subject matter of any one or more of Examples 22-23 optionally include wherein the means for identifying the set of members from the plurality of members based on the response score comprises means for identifying members from the plurality of members that match the member search criteria and that have a response score above a predetermined threshold.

In Example 25, the subject matter of any one or more of Examples 22-24 optionally include wherein the means for identifying the set of members comprises: means for determining an initial set of members of the social networking service that have response scores above a predetermined threshold; and means for searching the initial set of members based upon the search criteria to produce the set of members.

In Example 26, the subject matter of any one or more of Examples 22-25 optionally include wherein the means for identifying the set of members comprises: means for searching for an initial set of members based upon the search criteria to produce an initial set of members; and means for removing from the set of initial members, members that have response scores below a predetermined threshold to produce the set of members.

In Example 27, the subject matter of any one or more of Examples 22-26 optionally include wherein the means for calculating the response scores comprises means for calculating the response score based upon social networking service member information comprising usage features, communication features, and job opening features.

In Example 28, the subject matter of any one or more of Examples 22-27 optionally include wherein the means for calculating the response score comprises means for calculating the response score based upon a job seeker score that quantifies a predicted likelihood that the particular member is seeking employment, login data, profile quality score, and how frequently the particular member responds to communications from other members that are not connections.

Example 29 is a method displaying a user interface, the method comprising: displaying a graphical user interface (GUI) that includes a search input element; receiving via the search input element a search query including search criteria for identifying candidates for a job; displaying through the GUI a GUI element and a first plurality of candidates that satisfy the search query; and responsive to selecting the GUI element, displaying a second plurality of candidates, the second plurality of candidates a subset of the first plurality of candidates, each of the second plurality of candidates selected based on a particular response score determined for the candidate, the response score indicating that the candidate is more likely to respond.

In Example 30, the subject matter of Example 29 optionally includes wherein the GUI element is a tab.

In Example 31, the subject matter of any one or more of Examples 29-30 optionally include wherein the search input element comprises elements to select search criteria, the elements comprising one or more of: job title elements, location elements, skills elements, and companies elements.

In Example 32, the subject matter of any one or more of Examples 29-31 optionally include wherein displaying the second plurality of candidates comprises displaying the candidate's names and current employment information.

In Example 33, the subject matter of Example 32 optionally includes wherein displaying the second plurality of candidates comprises displaying a number of shared connections between a user entering the search query and the search candidates.

In Example 34, the subject matter of any one or more of Examples 29-33 optionally include wherein the GUI is displayed as part of the browser.

Example 35 is a non-transitory machine readable medium for displaying a user interface, the machine readable medium comprising instructions, that when executed by a machine, causes the machine to perform operations comprising: displaying a graphical user interface (GUI) that includes a search input element; receiving via the search input element a search query including search criteria for identifying candidates for a job; displaying through the GUI a GUI element and a first plurality of candidates that satisfy the search query; and responsive to selecting the GUI element, displaying a second plurality of candidates, the second plurality of candidates a subset of the first plurality of candidates, each of the second plurality of candidates selected based on a particular response score determined for the candidate, the response score indicating that the candidate is more likely to respond.

In Example 36, the subject matter of Example 35 optionally includes wherein the GUI element is a tab.

In Example 37, the subject matter of any one or more of Examples 35-36 optionally include wherein the search input element comprises elements to select search criteria, the elements comprising one or more of: job title elements, location elements, skills elements, and companies elements.

In Example 38, the subject matter of any one or more of Examples 35-37 optionally include wherein the operations of displaying the second plurality of candidates comprises displaying the candidate's names and current employment information.

In Example 39, the subject matter of Example 38 optionally includes wherein the operations of displaying the second plurality of candidates comprises displaying a number of shared connections between a user entering the search query and the search candidates.

In Example 40, the subject matter of any one or more of Examples 35-39 optionally include wherein the GUI is displayed as part of the browser.

Example 41 is a system for displaying a user interface, the system comprising: a processor; a memory communicatively coupled to the processor and comprising instructions, which when executed by the processor causes the system to perform operations comprising: displaying a graphical user interface (GUI) that includes a search input element; receiving via the search input element a search query including search criteria for identifying candidates for a job; displaying through the GUI a GUI element and a first plurality of candidates that satisfy the search query; and responsive to selecting the GUI element, displaying a second plurality of candidates, the second plurality of candidates a subset of the first plurality of candidates, each of the second plurality of candidates selected based on a particular response score determined for the candidate, the response score indicating that the candidate is more likely to respond.

In Example 42, the subject matter of Example 41 optionally includes wherein the GUI element is a tab.

In Example 43, the subject matter of any one or more of Examples 41-42 optionally include wherein the search input element comprises elements to select search criteria, the elements comprising one or more of: job title elements, location elements, skills elements, and companies elements.

In Example 44, the subject matter of any one or more of Examples 41-43 optionally include wherein the operations of displaying the second plurality of candidates comprises displaying the candidate's names and current employment information.

in Example 45, the subject matter of Example 44 optionally includes wherein the operations of displaying the second plurality of candidates comprises displaying a number of shared connections between a user entering the search query and the search candidates.

In Example 46, the subject matter of any one or more of Examples 41-45 optionally include wherein the GUI is displayed as part of the browser.

Example 47 is a device for displaying a user interface, the device comprising: means for displaying a graphical user interface (GUI) that includes a search input element; means for receiving via the search input element a search query including search criteria for identifying candidates for a job; means for displaying through the GUI a GUI element and a first plurality of candidates that satisfy the search query; and responsive to selecting the GUI element, means for displaying a second plurality of candidates, the second plurality of candidates a subset of the first plurality of candidates, each of the second plurality of candidates selected based on a particular response score determined for the candidate, the response score indicating that the candidate is more likely to respond.

In Example 48, the subject matter of Example 47 optionally includes wherein the GUI element is a tab.

In Example 49, the subject matter of any one or more of Examples 47-48 optionally include wherein the search input element comprises elements to select search criteria, the elements comprising one or more of job title elements, location elements, skills elements, and companies elements.

In Example 50, the subject matter of any one or more of Examples 47-49 optionally include wherein the means for displaying the second plurality of candidates comprises means for displaying the candidate's names and current employment information.

In Example 51, the subject matter of Example 50 optionally includes wherein the means for displaying the second plurality of candidates comprises means for displaying a number of shared connections between a user entering the search query and the search candidates.

In Example 52, the subject matter of any one or more of Examples 47-51 optionally include wherein the GUI is displayed as part of the browser.

What is claimed is:

1. A method for providing a graphical user interface (GUI), the method comprising:
using one or more processors of a social networking service, executing operations of:
for each particular member of a plurality of members of the social networking service, determining, using a machine learning algorithm, a response score for the particular member based upon one or more of: activity data describing the particular member's activity on the social networking service, and profile data, the response score indicative of a likelihood of the particular member to respond to an inquiry about a job from another member of the social networking service;
causing a search GUI to be displayed to a user, the search GUI including GUI elements that receive search criteria;
receiving through the search GUI, a search query with member search criteria;
responsive to the search query, identifying a set of members from the plurality of members based on the response score determined for each particular member from the set of members; and
causing the set of members to be displayed to the user as search results for the search query.

2. The method of claim 1, wherein receiving through the search GUI, the search query with member search criteria comprises:
receiving the member search criteria;
determining a set of relevant members based upon the member search criteria;
presenting the set of relevant members in the search GUI; and
receiving a selection of a GUI element of the search GUI indicating that the user is interested in other members that have high predicted propensities to respond.

3. The method of claim 1, wherein identifying the set of members from the plurality of members based on the response score comprises identifying members from the plurality of members that match the member search criteria and that have a response score above a predetermined threshold.

4. The method of claim 1, wherein identifying the set of members comprises:
determining an initial set of members of the social networking service that have response scores above a predetermined threshold; and
searching the initial set of members based upon the search criteria to produce the set of members.

5. The method of claim 1, wherein identifying the set of members comprises:
searching for an initial set of members based upon the search criteria to produce an initial set of members; and
removing from the set of initial members, members that have response scores below a predetermined threshold to produce the set of members.

6. The method of claim 1, wherein calculating the response scores comprises calculating the response score based upon social networking service member information comprising usage features, communication features, and job opening features.

7. The method of claim 1, wherein calculating the response score comprises calculating the response score based upon a job seeker score that quantifies a predicted likelihood that the particular member is seeking employment, login data, profile quality score, and how frequently the particular member responds to communications from other members that are not connections.

8. A non-transitory machine-readable medium comprising instructions, when executed by a machine, causes the machine to perform operations comprising:
for each particular member of a plurality of members of the social networking service, determining, using a machine learning algorithm, a response score for the particular member based upon one or more of: activity data describing the particular member's activity on the social networking service, and profile data, the response score indicative of a likelihood of the particular member to respond to an inquiry about a job from another member of the social networking service;
causing a search GUI to be displayed to a user, the search GUI including GUI elements that receive search criteria;
receiving through the search GUI, a search query with member search criteria;
responsive to the search query, identifying a set of members from the plurality of members based on the response score determined for each particular member from the set of members; and
causing the set of members to be displayed to the user as search results for the search query.

9. The non-transitory machine-readable medium of claim 8, wherein the operations of receiving through the search GUI, the search query with member search criteria comprises:
receiving the member search criteria;
determining a set of relevant members based upon the member search criteria;
presenting the set of relevant members in the search GUI; and
receiving a selection of a GUI element of the search GUI indicating that the user is interested in other members that have high predicted propensities to respond.

10. The non-transitory machine-readable medium of claim 8, wherein the operations of identifying the set of members from the plurality of members based on the response score comprises identifying members from the plurality of members that match the member search criteria and that have a response score above a predetermined threshold.

11. The non-transitory machine-readable medium of claim 8, wherein the operations of identifying the set of members comprises:
determining an initial set of members of the social networking service that have response scores above a predetermined threshold; and
searching the initial set of members based upon the search criteria to produce the set of members.

12. The non-transitory machine-readable medium of claim 8, wherein the operations of identifying the set of members comprises:
searching for an initial set of members based upon the search criteria to produce an initial set of members; and
removing from the set of initial members, members that have response scores below a predetermined threshold to produce the set of members.

13. The non-transitory machine-readable medium of claim 8, wherein the operations of calculating the response scores comprises calculating the response score based upon social networking service member information comprising usage features, communication features, and job opening features.

14. The non-transitory machine-readable medium of claim 8, wherein the operations of calculating the response score comprises calculating the response score based upon a job seeker score that quantifies a predicted likelihood that the particular member is seeking employment, login data, profile quality score, and how frequently the particular member responds to communications from other members that are not connections.

15. A method displaying a user interface, the method comprising:
displaying a graphical user interface (GUI) that includes a search input element;
receiving via the search input element a search query including search criteria for identifying candidates for a job;
displaying through the GUI a GUI element and a first plurality of candidates that satisfy the search query; and
responsive to selecting the GUI element, displaying a second plurality of candidates, the second plurality of candidates a subset of the first plurality of candidates, each of the second plurality of candidates selected based on a particular response score determined for the candidate, the response score indicating that the candidate is more likely to respond.

16. The method of claim 15, wherein the GUI element is a tab.

17. The method of claim 15, wherein the search input element comprises elements to select search criteria, the elements comprising one or more of: job title elements, location elements, skills elements, and companies elements.

18. The method of claim 15, wherein displaying the second plurality of candidates comprises displaying the candidate's names and current employment information.

19. The method of claim 18, wherein displaying the second plurality of candidates comprises displaying a number of shared connections between a user entering the search query and the search candidates.

20. The method of claim 15, wherein the GUI is displayed as part of the browser.
